(19) United States
(12) Patent Application Publication
(10) Pub. No.: US 2005/0066662 A1
(43) Pub. Date: Mar. 31, 2005

(54) Using solids as peroxide source for fuel cell applications, process and product thereof

(76) Inventor: Donald T. Cronce, Fredericksburg, VA (US)

Correspondence Address: Matthew J. Bussan, Esq., NSWCDD (XDC1), Dahlgren, VA, 22448-5100, US

(21) Appl. No.: 10/675,598

(22) Filed: Sep. 26, 2003

(51) Int. Cl. F02B 1/00

(52) U.S. Cl. 60/721

(57) ABSTRACT

An energy source for primary power generation uses a solid peroxide energy source and a solvent for liquefying the solid peroxide energy source.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor.

### BACKGROUND OF THE INVENTION

1. Field of the Invention

The present invention relates to using solid peroxide for providing a primary energy source.

2. Brief Description of the Related Art

Power generation has been disclosed in several patents. For example, liquid peroxides are disclosed in U.S. Pat. No. 3,898,794 to Ariga (decomposition of hydrogen peroxide in a power plant); U.S. Pat. No. 4,047,380 to Heffernan (decomposition of dilute hydrogen peroxide in a combustion system); U.S. Pat. No. 5,177,952 to Stone (use of hydrogen peroxide in a closed cycle power system); U.S. Pat. No. 6,250,078 to Amendola et al. (hydrogen peroxide as a fuel in an engine) and U.S. Pat. No. 6,255,009 to Rusek et al. (hydrogen peroxide for power generation). Additionally, solid peroxides used in ancillary power systems have been disclosed in U.S. Pat. No. 4,449,372 to Rilett (sodium peroxide, calcium peroxide, strontium peroxide and barium peroxide as heat source materials); U.S. Pat. No. 4,598,552 to Weber (generation of an oxygen reactant from a material that will decompose in the presence of water preferably sodium superoxide, potassium superoxide and other Group IA superoxides, that is used to heat and vaporize a working fluid); U.S. Pat. No. 6,156,136 to Bottaro et al. (oxidizer of sodium peroxide) and U.S. Pat. No. 6,367,244 to Smith et al. (solid-phase oxidizer of sodium peroxide retained with and suspended in liquid oxidizers).

There is a need in the art to provide a primary energy source for power generation from a solid peroxide. The present invention addresses this and other needs.

### SUMMARY OF THE INVENTION

The present invention includes an energy source for power generation comprising one or more solid material sources effective for producing a peroxide energy source and one or more solvents effective for liquefying the one or more solid material sources. Potassium superoxide is particularly useful as the peroxide energy source. The present invention also includes a power generator incorporating the energy source for power generation.

Additionally, the present invention also includes a process for releasing energy from a solid material, such as a solid peroxide, comprising the steps of providing an energy source for power generation having one or more solid material sources effective for producing a peroxide energy source and one or more solvents effective for liquefying the one or more solid material sources and solubilizing the one or more solid material sources in the one or more solvents to create a liquified peroxide effective for imparting energy for power generation. The present invention further includes the power generation product of this process.

### BRIEF DESCRIPTION OF THE DRAWINGS

FIG. 1 is a schematic diagram for the system and method for producing energy from a solid peroxide;

FIG. 2 is a power cycle schematic diagram for a submersible wet diver delivery powered by solid peroxide decomposition;

FIG. 3 is a schematic diagram for the power phase of the combined cycle of the present invention for use in a land vehicle;

FIG. 4 is a schematic diagram for the power phase of the combined cycle of the present invention for use in a spacecraft; and,

FIG. 5 is a schematic diagram for the power phase of the combined cycle of the present invention for use in an aerial vehicle.

### DETAILED DESCRIPTION OF THE PREFERRED EMBODIMENT

The present invention provides an energy source for power generation. The energy source includes one or more solid material sources effective for producing a peroxide energy source and additionally one or more solvents effective for liquefying the solid material sources. This energy source for power generation is particularly useful as a primary power source. The solid material is liquified by an appropriate solvent for use in a fuel cell. The decomposing solid material, and/or later liquid derivative, provides a primary energy source for power generation.

The solid material sources includes a solid peroxide or source material for creating a liquified peroxide. Representative solid peroxides include peroxides and superoxides, including combinations of the peroxides and superoxides. Representative examples of these peroxides and superoxides include sodium peroxide (Na₂O₂), potassium peroxide (K₂O₂), lithium peroxide (Li₂O₂), potassium superoxide (KO₂) and urea peroxide (CO(NH₂)₂.H₂O₂). Representative source material for creating a peroxide in liquid include sodium perborate (NaBO₃), peracetic acid (CH₃COOOH), peracetic salt, persulfate acid, persulfate salt, peroxide adduct, percarbonate acid and percarbonate salt. Of these, sodium peroxide, potassium peroxide and potassium superoxide are preferred, with potassium superoxide being most preferred.

The solvents of the present invention may include water, polar organic alcohols and polar organics, including combinations of these solvents. Representative polar organic alcohols include ethanol, methanol, isopropanol. Representative polar organics include propylene glycol. Water is the preferred solvent for decomposition of the solid peroxide.

The energy source of the present invention is useful in power generation, particularly as a primary energy source for a power generator, such as the energy source using a potassium superoxide component. Uses for the primary energy source may be similar to the uses of the hydrogen peroxide disclosed in U.S. Pat. No. 6,255,009 to Rusek et al., entitled “Combined Cycle Power Generation Using Controlled Hydrogen Peroxide Decomposition”, the disclosure of which is herein incorporated by reference for the teachings of systems powered by peroxide.

Decomposition of the solid material, caused by the solubilizing of the solid material by the solvent(s), creates the liquified peroxide. Representative reactions include:

| | | |
|---|---|---|
| Na₂O₂ + water | → | 2Na⁺ + O₂²⁻ |
| K₂O₂ + ethanol | → | 2K⁺ + O₂²⁻ |
| Li₂O₂ + methanol | → | 2Li⁺ + O₂²⁻ |
| KO₂ + water | → | 2K⁺ + O₂²⁻ + O₂ |
| CO(NH₂)₂ · H₂O₂ + water | → | Urea + H₂O₂ |

In operation, energy is released from the energy source, detailed herein, by solubilizing the solid material sources in the solvent(s) in a manner that decomposes the solid material into a liquified peroxide composition that effectively imparts energy for power generation. This produces power generation that is clean and efficient. The present invention is a system and process for providing chemical energy for devices to perform work, such as providing a motive force to carriers, such as on board naval vessels, aircraft, spacecraft, and/or land vehicles, using solid peroxide as the primary reactant. The liquid peroxide comprises an impellant. An impellant is a chemical which contains energy releasable by decomposition without combustion. The solid material, when decomposed, powers electric and/or propulsion systems on carriers and/or serves as the primary power source and/or auxiliary equipment on other like devices. Sizes of the turbine and/or electric motor drives are proportional to the anticipated use requirement, such as the size of the carrier or moving distance of a lever arm. The solid material, used to create the liquified peroxide, based impellant minimizes toxic emissions, increases reliability and efficiency, reduces sound, and obscures carrier signature relative to conventional fuels. Additionally, the replenishable and environmentally clean impellant may reduce logistic problems in the storage, distribution, transportation and supply of the impellant from reduced size and weight of the solid material relative to liquid hydrogen peroxide, which improves the reaction time of logistical support.

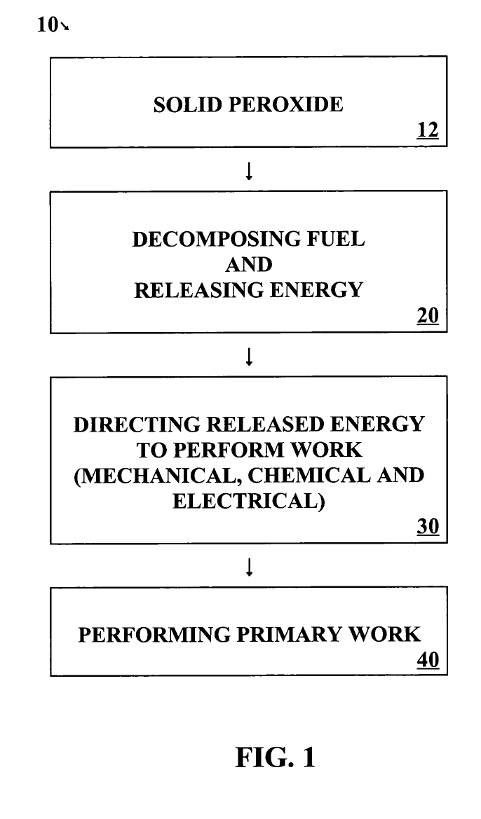

As seen in FIG. 1, the power system and process for performing work 10 comprises the steps of providing the energy source of a solid material such as solid peroxide 12, decomposing the solid peroxide 12 effective for the decomposition to release energy 20 and directing the released energy 20 to perform work 30. Performed work 30 includes mechanical, electrical and chemical work. As such, the solid peroxide acts as a primary power source 40, such as a fuel or propellant. As an example, the performed work may be used on any mechanical device which may use pressure-volume work to function. These mechanical devices include, but are not limited to, turbines, Stirling cycle engines, mechanical heat engines, lifts, presses, retractors, extenders, and other applications of internal combustion to engines, diesel engines, and the like. The performed work may replace work performed by these mechanical devices, including internal combustion engines, diesel engines and any other such devices. Preferably, the pressure-volume work drives carriers. Vehicles move from one location to another, and use a variety of locomotion means, such as propellers, wheels, tracks, thrusters, and the like. Chemically and electrically, the performed work may include providing a heating element, charging a battery, providing an electrical current, and the like. Amounts of residual products, such as water, water vapor and/or oxygen, may be in the impellant in any amount which does not interfere with the function of the impellant. The solid peroxide 12 may include additional components which include but are not limited to appropriate storage stabilizers or chemical reaction inhibitors, which are known to those skilled in the art. Depending on the amount of residual products and additives, the energy content of solid peroxide 12 approximately one-half the energy content of conventional fuels, but efficiencies in extracting the energy is approximately three times greater than conventional systems.

As previously detailed, the present invention includes a power system comprising an energy source of the solid peroxide 12, means for decomposing the solid peroxide 12 to release energy and means for producing work 30 from the released energy 20. The power system 10 provides released energy which provides mechanical, electrical, and/or chemical work in the primary and auxiliary systems of mechanical devices, such as carriers, and/or environmental conditioning, such as heat. As such, the solid peroxide 12 powers carriers or stationary devices without expending environmentally damaging waste from peroxide residue. The solid peroxide 12 also is universally applicable to many different types of carriers, including land, waterborne, airborne, and space-borne vehicles.

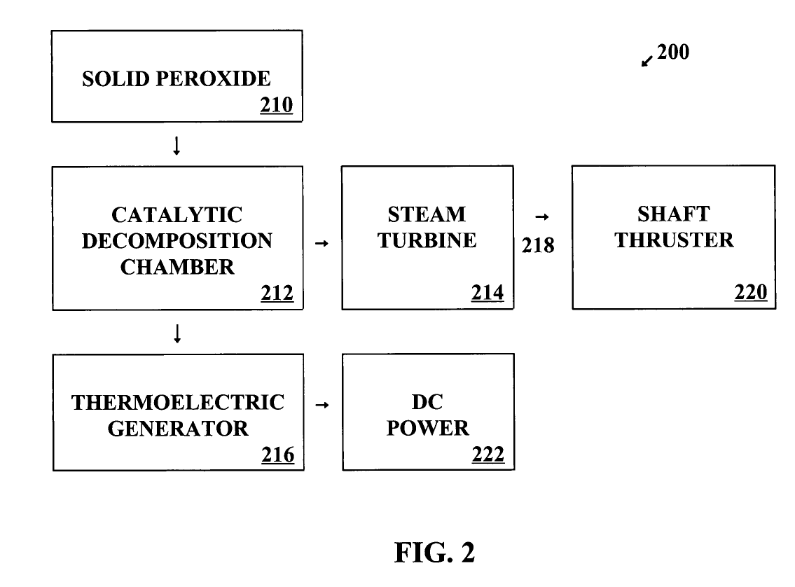

FIG. 2 is a power cycle schematic diagram for a submersible wet diver delivery vehicle powered by hydrogen peroxide decomposition. Referring to FIG. 2, the power source for the submersible wet diver delivery power cycle 200 comprises a solid peroxide holding tank. Solid peroxide 210 is decomposed in the catalytic decomposition chamber 212, also called a solid state catalytic reactor. Water vapor and oxygen, at a temperature of 1200° F., exit the solid state catalytic reactor 212 and are fed into the steam turbine 214 and the thermoelectric or thermionic generator 216. The steam turbine 214 provides shaft work 218 to power a shaft thruster 220. After the 1200° F. superheated steam and oxygen enter the thermoelectric or thermionic generator 216, on board DC power 222 is produced. The major components within the submersible wet diver delivery power cycle 200 contain a minimum number of moving parts, which provide for reliability and easy maintenance. The catalytic decomposition chamber 212 has no moving parts, the steam turbine 214 has one moving part, and the thermoelectric or thermionic generator 216 has no moving parts.

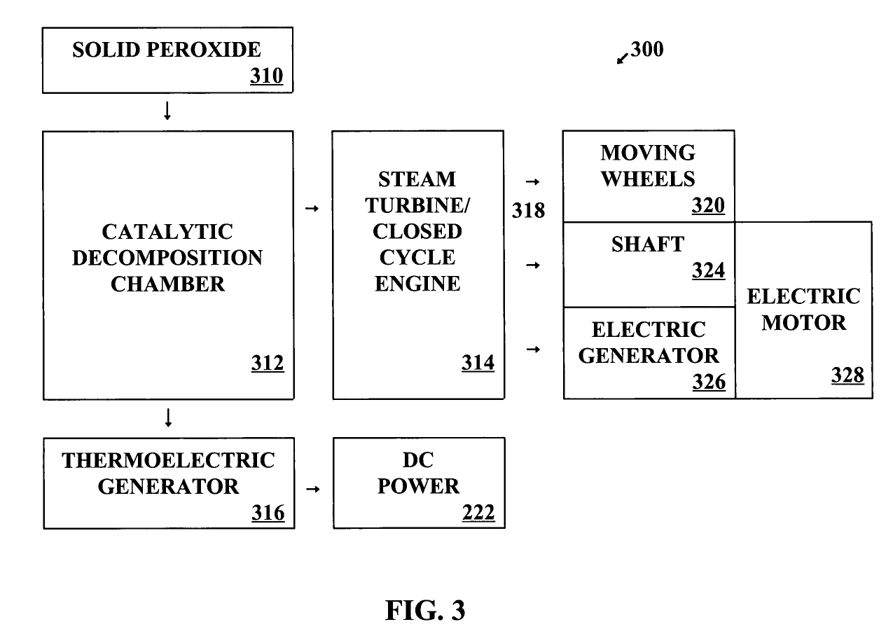

FIG. 3 is a schematic diagram for the power phase of the combined cycle of the present invention for use in a land vehicle, such as a tank. As shown in FIG. 3, the power source for the land vehicle power cycle 300 comprises a holding tank, which may be supplied from a solid peroxide production facility. Solid peroxide 310 is decomposed in the catalytic decomposition chamber 312. Water vapor and oxygen, at a temperature of 1200° F., exit the catalytic decomposition chamber 312 and are fed into the steam turbine 314 and the thermoelectric or thermionic generator 316. The steam turbine 314 provides shaft work 318 to power moving wheels or tracks 320. The shaft work 318 powers moving wheels 320, or may be used in any convenient powering form, such as rotary, oscillating, piston and like motion devices. Additionally, the steam turbine 314 may power a shaft 324, electric generator 326, electric motor 328 combination and/or system. After the 1200° F. superheated steam and oxygen enter the thermoelectric or thermionic generator 316, and DC power 322 is is produced for electrical systems. The water and oxygen exit the thermoelectric or thermionic generator 316 also to the DC power 322.

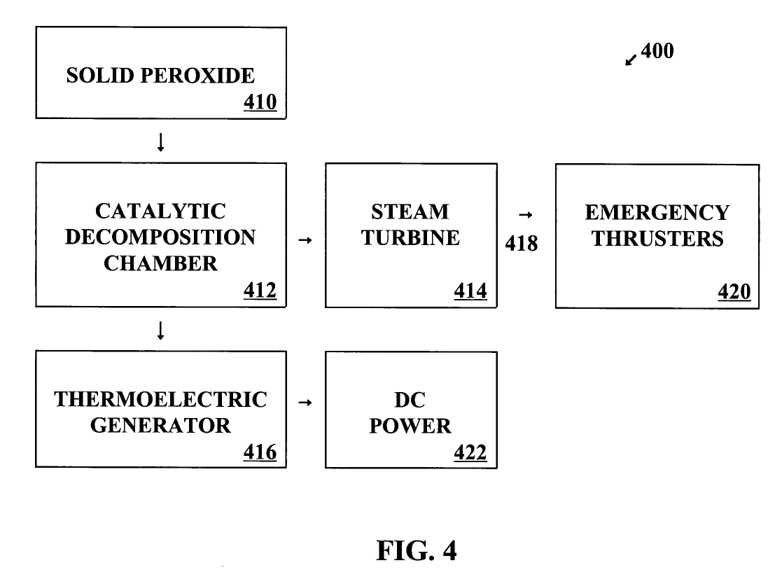

FIG. 4 is a schematic diagram for the power phase of the combined cycle of the present invention for use in manned missions in spacecraft. A spacecraft includes carriers which travel through space, facilities located on extraterrestrial bodies, and other such manmade devices used beyond the earth's atmosphere. Referring to FIG. 4, the power source for the spacecraft power cycle 400 comprises a solid peroxide holding tank. Solid peroxide 410 is decomposed in the catalytic decomposition chamber 412. Water vapor and oxygen, at a temperature of 1200° F., exit the catalytic decomposition chamber 412 and are fed into a steam turbine 414 or thruster, and the thermoelectric or thermionic generator 416. The steam turbine 414 provides shaft work 418 to power emergency thrusters 420. After the 1200° F. superheated steam and oxygen enter the thermoelectric or thermionic generator 416, and DC power 422 is produced for electrical systems.

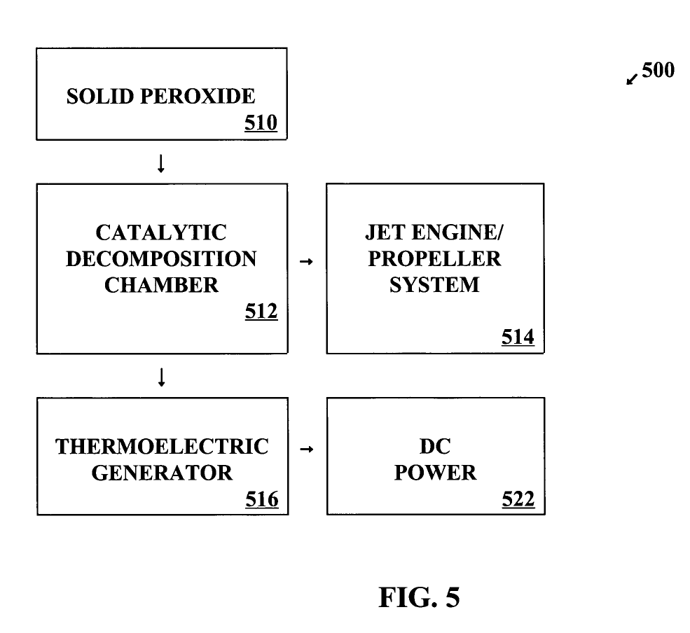

FIG. 5 is a schematic diagram for the power phase of the combined cycle of the present invention for use in an aerial vehicle. Aerial vehicles include carriers such as helicopters, jet craft, unmanned aerial vehicles and other such manmade devices used for flight in the earth's atmosphere. As shown in FIG. 5, the power source for the aerial vehicle power cycle 500 comprises a solid peroxide holding tank. Solid peroxide 510 is decomposed in the catalytic decomposition chamber 512. Water vapor and oxygen, at a temperature of 1200° F., exit the catalytic decomposition chamber 512 and are fed into the jet engine/propeller system 514 and the thermoelectric or thermionic generator 516. The jet engine/propeller system 514 provides motive force. After the 1200° F. superheated steam and oxygen enter the thermoelectric or thermionic generator 516, and DC power 522 is produced for electrical systems.

The present invention provides a logistically superior power source from an energy source that is easier to transport and handle than hydrogen peroxide energy sources. Highly concentrated solutions of hydrogen peroxide possess an explosion hazard, not present in the present invention. Large quantities of the solid peroxide occupy less volume and less weight than concentrated hydrogen peroxide solution for the same quantity of reactive peroxide.

The foregoing summary, description, and examples of the present invention are not intended to be limiting, but are only exemplary of the inventive features which are defined in the claims.

1. An energy source for power generation, comprising:
one or more solid material sources effective for producing a peroxide energy source; and,
one or more solvents effective for liquefying the one or more solid material sources.

2. The energy source of claim 1, wherein the one or more solid material sources comprise a solid peroxide.

3. The energy source of claim 2, wherein the solid peroxide is selected from the group consisting of peroxide, superoxide and combinations thereof.

4. The energy source of claim 1, wherein the solid material is selected from the group consisting of sodium peroxide, potassium peroxide, lithium peroxide, potassium superoxide, urea peroxide, sodium perborate, peracetic acid, peracetic salt, persulfate acid, persulfate salt, peroxide adduct, percarbonate acid, percarbonate salt and combinations thereof.

5. The energy source of claim 4, wherein the solid peroxide is selected from the group consisting of sodium peroxide, potassium peroxide, potassium superoxide and combinations thereof.

6. The energy source of claim 5, wherein the solid peroxide comprises potassium superoxide.

7. The energy source of claim 3, wherein the one or more solvents are selected from the group consisting of water, polar organic alcohols, polar organics, and combinations thereof.

8. The energy source of claim 7, wherein the one or more solvents are selected from the group consisting of water, propylene glycol, ethanol, methanol, isopropanol and combinations thereof.

9. The energy source of claim 8, wherein the one or more solvents comprises water.

10. A power generator comprising the primary energy source of claim 1.

11. A primary power generator comprising the energy source of claim 4.

12. A process for releasing energy in an energy source, comprising the steps of:
providing an energy source for power generation having one or more solid material sources effective for producing a peroxide energy source and one or more solvents effective for liquefying the one or more solid material sources; and,
solubilizing the one or more solid material sources in the one or more solvents to create a liquified peroxide effective for imparting energy for power generation.

13. The process of claim 12, wherein the solid material is selected from the group consisting of peroxide, superoxide and combinations thereof.

14. The process of claim 12, wherein the solid material is selected from the group consisting of sodium peroxide, potassium peroxide, lithium peroxide, potassium superoxide, urea peroxide, sodium perborate, peracetic acid, peracetic salt, persulfate acid, persulfate salt, peroxide adduct, percarbonate acid, percarbonate salt and combinations thereof.

15. The process of claim 14, wherein the solid peroxide is selected from the group consisting of sodium peroxide, potassium peroxide, potassium superoxide and combinations thereof.

16. The process of claim 15, wherein the solid peroxide comprises potassium peroxide.

17. The process of claim 12, wherein the one or more solvents are selected from the group consisting of water, polar organic alcohols, polar organics, and combinations thereof.

18. The process of claim 17, wherein the one or more solvents are selected from the group consisting of water, propylene glycol, ethanol, methanol, isopropanol and combinations thereof.

19. The process of claim 18, wherein the one or more solvents comprises water.

20. A power generation product produced by the process of claim 12.
